(19) United States
(12) Patent Application Publication
(10) Pub. No.: US 2025/0056204 A1
(43) Pub. Date: Feb. 13, 2025

(54) APPARATUS AND METHOD FOR ANALYTICS SUBSCRIPTION IN A WIRELESS NETWORK

(71) Applicant: Lenovo (Singapore) Pte. Ltd., New Tech Park (SG)

(72) Inventor: Roozbeh Atarius, La Jolla, CA (US)

(21) Appl. No.: 18/797,318

(22) Filed: Aug. 7, 2024

Related U.S. Application Data
(60) Provisional application No. 63/518,304, filed on Aug. 8, 2023.

(51) Int. Cl. H04W 8/18; H04W 24/10

(52) U.S. Cl. CPC H04W 8/18; H04W 24/10

(57) ABSTRACT

Various aspects of the present disclosure relate to: receiving, from a first device, a message including: an indication identifying a service or an application; and an indication identifying an analytics associated with the service or the application; transmitting, to a second device, a request for a subscription to the analytics; receiving, from the second device, a response associated with the analytics; and transmitting, to the first device, the response associated with the analytics.

### TECHNICAL FIELD

The present disclosure relates to wireless communications, and more specifically to analytics subscription in a wireless network.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may further include receiving, from a first device, a message comprising: an indication identifying a service or an application; and an indication identifying an analytics associated with the service or the application; transmitting, to a second device, a request for a subscription to the analytics; receiving, from the second device, a response associated with the analytics; and transmitting, to the first device, the response associated with the analytics.

### BRIEF DESCRIPTION OF THE DRAWINGS

FIG. 1 illustrates an example of a wireless communications system in accordance with aspects of the present disclosure.

FIG. 2 illustrates an example of an application data analytics enablement (ADAE) internal function architecture in accordance with aspects of the present disclosure.

FIG. 3 illustrates an example of an ADAE procedure in accordance with aspects of the present disclosure.

FIG. 4 illustrates an example of a uniform resource identifier (URI) structure of an ADAE service (ADAES) configuration application programming interface (API) in accordance with aspects of the present disclosure.

FIG. 5 illustrates an example of a user equipment (UE) in accordance with aspects of the present disclosure.

FIG. 6 illustrates an example of a processor in accordance with aspects of the present disclosure.

FIG. 7 illustrates an example of a network equipment (NE) in accordance with aspects of the present disclosure.

FIG. 8 illustrates a flowchart of a method performed by a NE in accordance with aspects of the present disclosure.

### DETAILED DESCRIPTION

Various aspects of the present disclosure relate to a system that supports analytics subscription. In some cases, functional descriptions of an ADAE layer may be unorganized and/or undefined for effective and efficient operation. To provide organization and/or definition, a resource URI may be defined to provide a structure. The resource URI structure may identify an ADAE service, analytics, and/or resource configuration to indicate a functional description. By having a defined resource URI, an ADAE layer may be used more efficiently during operation.

The ADAE layer may be configured to or operable to support performance analytics for an application to provide insight on the operation and performance of the application, such as statistics or prediction on parameters related to the application. In some implementations, the ADAE layer may be configured to or operable to support network slice-specific performance analytics associated with an application to provide insight on the performance of the application (e.g., one or more VAL applications) when using the network slice (e.g., from a list of subscribed network slices for a VAL customer). In some other implementations, the ADAE layer may be configured to or operable to support UE-to-UE performance analytics associated with an application and track derivation and exposure of application layer analytics to predict the performance of a session associated with the application and between the UEs (e.g., two or more VAL UEs within a service or group). This prediction may relate to application quality of service (QOS) attribute prediction for a time horizon and area. In other implementations, the ADAE layer may be configured to or operable to support analytics associated with location accuracy to allow a VAL server to be notified, where the analytics may indicate whether the accuracy of a location can be met for an application and optionally for a route of a UE or a group of UEs.

Additionally, or alternatively, the ADAE layer may be configured to or operable to support service API analytics to allow a VAL server or any other consumer (e.g., API provider) to be notified on a predicted and/or statistic availability and service level for requested service API analytics. In some implementations, the ADAE layer may be configured to or operable to support slice usage pattern analytics to provide network slice usage pattern analytics based at least in part on collected network slice performance and analytics, historical network slice status, and network performance to help the analytics consumer manage the network slice. In some other implementations, the ADAE layer may be configured to or operable to support edge load analytics to provide insight on the operation and performance of an edge domain name (EDN) and, particularly, statistics or predictions on parameters related to an edge application server (EAS)/edge enabler server (EES) load for one or more EAS/EES and/or edge platform load parameters. The edge platform load parameters may include an aggregate of load per EDN or per DN access identifier (DNAI) due to edge support services and edge computational resources (e.g., load level). In other implementations, the ADAE layer may be configured to or operable to support the collection of service experience information from one or multiple ADAE clients to support application performance analytics.

Aspects of the present disclosure are described in the context of a wireless communications system.

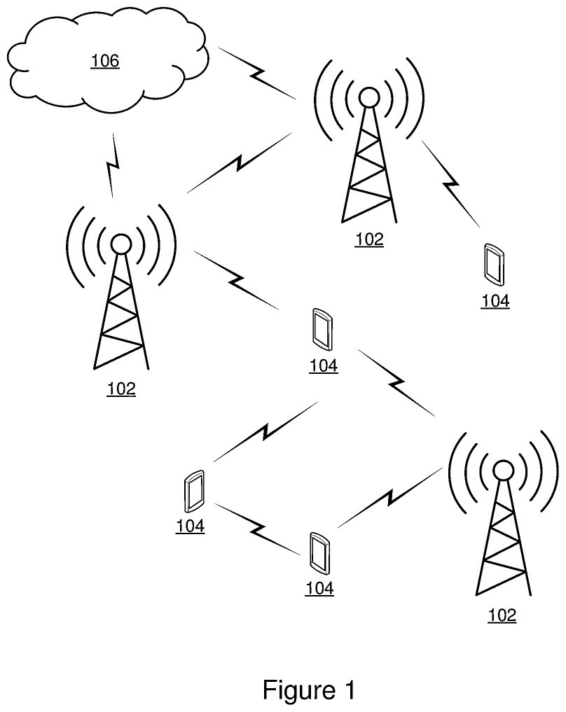

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a UE-to-UE interface (PC5 interface).

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHZ), FR4a or FR4-1 (52.6 GHz-71 GHZ), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

To implement the functional descriptions of an ADAE layer, a resource URI may be defined with a general structure. The resource URI structure may identify an ADAE service, analytics, and/or resource configuration. The NE 102 and/or UE 104 may execute a set of instructions to perform the described functions.

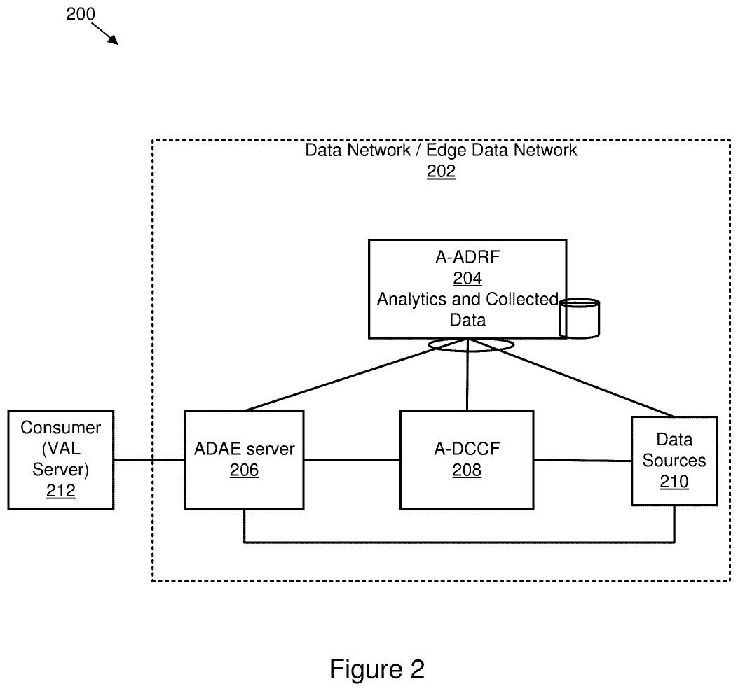

FIG. 2 illustrates an example of an ADAE architecture in accordance with aspects of the present disclosure. The ADAE architecture may implement or be implemented by one or more aspects of the wireless communications system 100. The ADAE architecture may be an example of an ADAE internal function architecture. In some implementations, the ADAE architecture may be a functional model for ADAE when implementing a third-generation partnership project (3GPP) network data analytics model. In the example of FIG. 2, a system 200 may include a data network/edge data network 202 that includes an application layer-analytical data repository function (A-ADRF) 204, an ADAE server 206, an application layer-data collection and coordination function (A-DCCF) 208, and data sources 210. The system 200 may also include a consumer 212 (e.g., a vertical application layer (VAL) server).

The consumer 212, for example, via the ADAE server 206 may submit a request for data (e.g., data analytics of a VAL application). The A-DCCF 208 may be configured to coordinate a collection and distribution of data requested by the consumer (e.g., the ADAE server 206). The data collection coordination is supported by the A-DCCF 208. The ADAE server 206 may be configured to, or operable to, send the request for the data to the A-DCCF 208, which may obtain the requested data from the data sources 210. As such, the ADAE server 206 may indirectly transmit the request for the data to the data sources 210 via the A-DCCF 208 rather than directly to the data sources 210. The A-DCCF 208 may also perform data processing, data abstraction, and/or data preparation based at least in part on requirements of the consumer 212 (e.g., the VAL server).

The A-ADRF 204 may be configured to, or operable to, store historical data and/or analytics (e.g., data and/or analytics related to a previous period and obtained by a consumer (e.g., the ADAE server 206)). After the consumer obtains the data and/or analytics, the consumer may store historical data and/or analytics in a repository (e.g., buffer, memory, database) associated with the A-ADRF 204. Whether the consumer directly contacts the A-ADRF 204 or communicates via the A-DCCF 208 is based at least in part on a configuration.

The data sources 210 may be 5G system (5GS) data sources (e.g., 5G core (5GC), operations and management (OAM)) or enablement layer data sources (e.g., service enabler architecture layer (SEAL), edge enabler layer (EEL)) or external data sources at a data network (DN) side (e.g., VAL server and/or EAS) and VAL UEs. The A-DCCF 208 and the A-ADRF 204 may enable communication with certain data sources (e.g., 5GC, OAM) based at least in part on the configuration. For example, the A-DCCF 208 and the A-ADRF 204 may enable the system, including the consumer 212 to communicate with these data sources to retrieve, receive, read, obtain, store, transmit, or any combination thereof, data. Additionally, the A-DCCF 208 and the A-ADRF 204 may not have any interaction with the VAL.

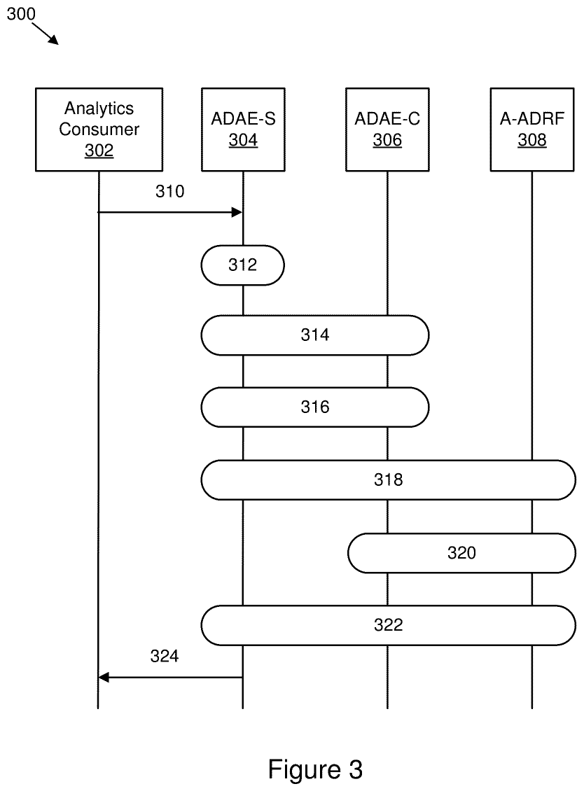

FIG. 3 illustrates an example of an ADAE procedure 300 in accordance with aspects of the present disclosure. The ADAE procedure 300 may implement or be implemented by one or more aspects of the wireless communications system 100. The ADAE procedure 300 may include an analytics consumer 302, an ADAE server (ADAE-S) 304, an ADAE client (ADAE-C) 306, and an A-ADRF 308. The operations between the analytics consumer 302, the ADAE-S 304, the ADAE-C 306, and/or the A-ADRF 308 may occur in a different order or at different times than as shown. Some operations may also be omitted from the ADAE procedure 300, and other operations may be added to the ADAE procedure 300.

In the example of FIG. 3, the analytics consumer 302 may request subscription to analytics or request the analytics without subscription. The subscription or the request may be for analytics associated with a current session. Additionally, or alternatively, the subscription or the request may be for historical analytics associated with a previous session.

At 310, the analytics consumer 302 may transmit a request to the ADAE-S 304 for analytics of a service. Alternatively, at 310, the analytics consumer 302 may subscribe to the ADAE-S 304 for analytics of the service. At 312, the ADAE-S 304 may evaluate whether the request for, or the subscription to, the analytics is for a current session (e.g., current analytics data) or for a previous session (e.g., historical analytics data).

At 314, the ADAE-S 304 may transmit, or output, a request for the analytics of the service to the ADAE-C 306, for example, based at least in part on determining that the request for, or the subscription to, the analytics is for a current session. The request may be for a subscription to the analytics. In some implementations, the ADAE-C 306 may transmit, or output, to the ADAE-S 304, analytics data in response to a condition (e.g., such as a threshold for an amount of data or a certain interval) being satisfied (e.g., fulfilled), which may be a trigger (e.g., an indication) to the ADAE-C 306 to notify the ADAE-S 304. At 316, the ADAE-C 306 may determine that the condition is satisfied and transmit, or output, the analytics data to the ADAE-S 304 in response to the condition being satisfied.

Alternatively, at 318, the ADAE-S 304 may transmit, or output, a request for historical analytics to the A-ADRF 308, for example, based at least in part on determining that the request for, or the subscription to, the analytics is for a previous session. In some implementations, the A-ADRF 308 may transmit, or output, to the ADAE-S 304, the historic analytics data in response to a condition being satisfied (e.g., fulfilled), which may be a trigger (e.g., an indication) to the A-ADRF 308 to notify the ADAE-S 304 of the historic analytics data.

At 320, the A-ADRF 308 may collect (e.g., receive, retrieve, obtain) the historic analytics data from the ADAE-C 306. It should be noted that the A-ADRF 308 may collect the historic analytics data irrespective of (e.g., without) receiving a request from the ADAE-S 304 for the historic analytics data. At 322, the A-ADRF 308 may output, or transmit, the historic analytics data to the ADAE-S 304 based at least in part on the condition being satisfied.

At 324, upon receipt of the analytics data or the historic analytics data, the ADAE-S 304 may transmit the analytics to the analytics consumer 302. In some implementations, the ADAE-S 304 may determine whether to transmit the analytics to the analytics consumer 302, and based at least in part on the determination may transmit the analytics to the analytics consumer 302.

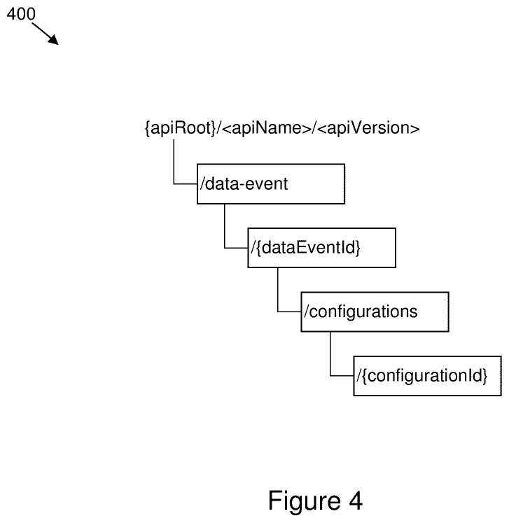

FIG. 4 illustrates an example of a URI structure 400 of an ADAES configuration API in accordance with aspects of the present disclosure.

The resource URI may be used as a hypertext transfer protocol (HTTP) URI, which is used in an HTTP protocol for ADAE services has a resource URI structure according to FIG. 4 with {apiRoot} set to the value of “adaes”, thus, {apiRoot}/adaes/<apiVersion>/data-event/{dataEventId}/configurations/{configurationId}, where: a) “dataEventId” is set to an identity of an event for an ADAE service (e.g., ADAES); and b) “configurationID” is set to the identity of the resource configuration.

If the consumer has subscribed to the analytics for a service, Table 1 provides an overview of the resource and applicable HTTP method for the resource URI “{apiRoot}/{adaes}/data-event/{dataEventId}/configurations/{configurationId}”, where “dataEventId” identifies the identity of an event for the analytics and “configurationId” identifies the resources.

TABLE 1
Resource Names and HTTP Methods Overview

| | HTTP | |
|---|---|---|
| Resource name | method | Description |
| Analytics | POST | This configuration is used by: |
| subscription | | an authorized consumer to subscribe |
| configuration | | to the ADAE-S; or |
| | | the ADAE-S to subscribe to the ADAE-C, |
| | | for the service analytics. |
| Analytics | POST | This configuration is used by: |
| notification | | the ADAE-S to notify an authorized |
| configuration | | consumer; or |
| | | the ADAE-C to notify the ADAE-S, |
| | | the service analytics. |
| Data collection | POST | This configuration is used by the |
| subscription | | ADAE-S to subscribe to the data producer |
| configuration | | for the analytics data collection. |
| Data collection | POST | This configuration is used by the data |
| notification | | producer to notify to the ADAE-S the |
| configuration | | analytics data collection. |
| Analytics request | GET | This configuration is used by an A-ADRF |
| configuration | | to get the analytics from the ADAE-C. |
| Analytics response | 200 | This configuration is used by the ADAE-C |
| configuration | (OK) | to provide the A-ADRF the analytics. |

Due to the identity of the ADAE service, the resources may be determined. Table 2 provides an example of parameters supported by the HTTP POST request payload to subscribe to the analytics.

TABLE 2
Supported Parameters by HTTP POST Request Body

| Parameter name | P | Description |
|---|---|---|
| Analytics filter | Mandatory | Filter information for the analytics event. |
| information | | |
| Analytics type | Mandatory | To identify whether the analytics is |
| | | prediction or statistics. |
| VAL service ID | Mandatory | The identifier of the service which is an |
| | | VAL service, to which the performance |
| | | analytics subscription is applied. |
| Confidence level | Optional | To define the accuracy level for the |
| | | analytics if the analytics is prediction. |
| Validity area | Optional | The geographical or service area, to |
| | | which the analytics subscription is applied. |
| Validity time | Optional | The time interval, to which the |
| | | analytics subscription is applied. |

Table 3 provides the possible responses to the HTTP POST request for the subscription to the analytics.

TABLE 3
HTTP Responses

| HTTP Response | P | Description |
|---|---|---|
| 202 (Accepted) | | Subscription to the analytics is accepted. |
| 401 (Unauthorized) | | The consumer for the subscription to the |
| | | analytics has failed the authorization and |
| | | cannot subscribe to the event. |

The resource URI may be used as a constrained application protocol (CoAP) URI which is used in a CoAP protocol for ADAE services has a resource URI structure according to FIG. 4 with {apiRoot} set to the value of “adaes”, thus, {apiRoot}/adaes/<apiVersion>/data-event/{dataEventId}/configurations/{configurationId}, where: a) “dataEventId” is set to an identity of an event for an ADAE service (e.g., ADAES); and b) “configurationID” is set to the identity of the resource configuration.

If the consumer has subscribed to the analytics for a service, Table 4 provides an overview of the resource and applicable CoAP method for the resource URI “{apiRoot}/{adaes}/data-event/{dataEventId}/configurations/{configurationId}”, where “dataEventId” identifying the identity of an event for the analytics and “configurationId” identifying the resources.

TABLE 4
Resource names and CoAP Methods Overview

| | CoAP | |
|---|---|---|
| Resource name | method | Description |
| Analytics | POST | This configuration is used by: |
| subscription | | an authorized consumer to subscribe |
| configuration | | to the ADAE-S; or |
| | | the ADAE-S to subscribe to the ADAE-C, |
| | | for the service analytics. |
| Analytics | POST | This configuration is used by: |
| notification | | the ADAE-S to notify an authorized |
| configuration | | consumer; or |
| | | the ADAE-C to notify the ADAE-S, |
| | | the service analytics. |
| Data collection | POST | This configuration is used by the |
| subscription | | ADAE-S to subscribe to the data producer |
| configuration | | for the analytics data collection. |
| Data collection | POST | This configuration is used by the data |
| notification | | producer to notify to the ADAE-S the |
| configuration | | analytics data collection. |
| Analytics request | GET | This configuration is used by an A-ADRF |
| configuration | | to get the analytics from the ADAE-C. |
| Analytics response | 2.05 | This configuration is used by the ADAE-C |
| configuration | Content | to provide the A-ADRF the analytics. |

Due to the identity of the ADAE service, the resources can be determined. Table 5 provides an example for the attributes which are supported by the POST request payload to subscribe to the analytics.

TABLE 5
Supported Attributes by CoAP POST Request Body

| Attributes | Data | | | |
|---|---|---|---|---|
| name | type | P | Cardinality | Description |
| Analytics | String | Mandatory | 1 | Filter information for the |
| filter | | | | analytics event. |
| information | | | | |
| Analytics | String | Mandatory | 1 | To identify whether the analytics is |
| type | | | | prediction or statistics. |
| VAL | String | Mandatory | 1 | The identifier of the service which is an |
| service ID | | | | VAL service, to which the performance |
| | | | | analytics subscription is applied. |
| Confidence | String | Optional | 0..1 | To define the accuracy level for the |
| level | | | | analytics if the analytics is prediction. |
| Validity | String | Optional | 0..1 | The geographical or service area, to which |
| area | | | | the analytics subscription is applied. |
| Validity | String | Optional | 0..1 | The time interval, to which the |
| time | | | | analytics subscription is applied. |

Table 6 provides the possible responses to the CoAP POST request for the subscription to the analytics.

TABLE 6
CoAP Responses

| | | | | |
|---|---|---|---|---|
| | Data | | | |
| Response | type | P | Cardinality | Description |

| | | |
|---|---|---|
| 2.01 Created | n/a | Subscription to the |
| | | analytics is accepted. |
| 4.01 | n/a | The consumer for the |
| Unauthorized | | subscription to the analytics |
| | | has failed the authorization |
| | | and cannot subscribe to the |
| | | event. |

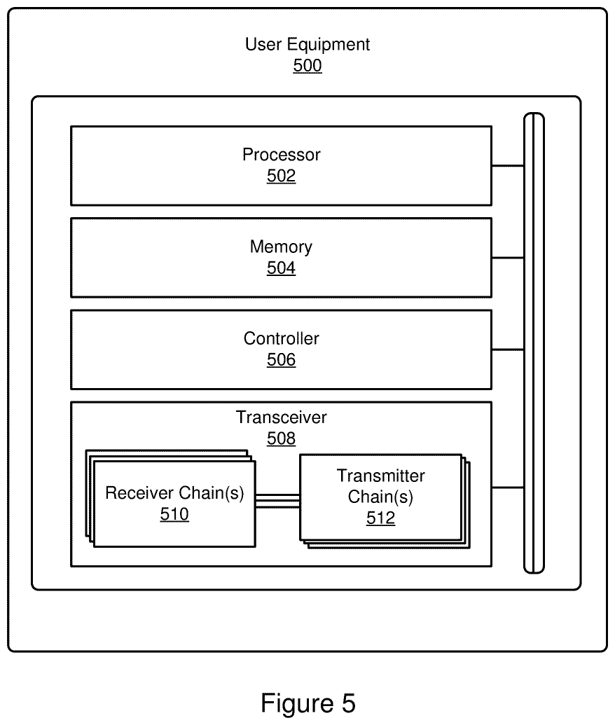

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, a field programmable gate array (FPGA), or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receive the signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

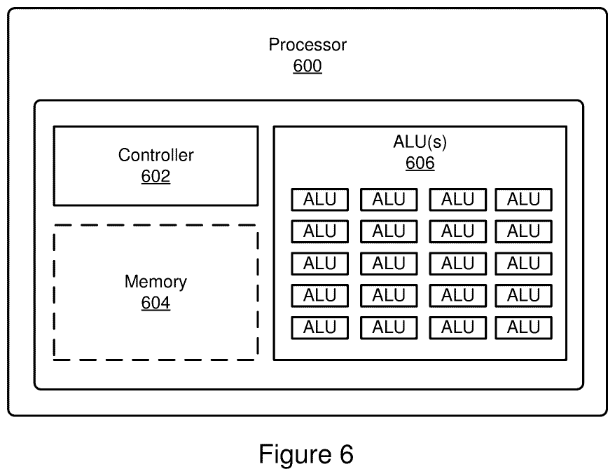

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to support a means for receiving, from a first device, a message comprising: an indication identifying a service or an application; and an indication identifying an analytics associated with the service or the application; transmitting, to a second device, a request for a subscription to the analytics; receiving, from the second device, a response associated with the analytics; and transmitting, to the first device, the response associated with the analytics.

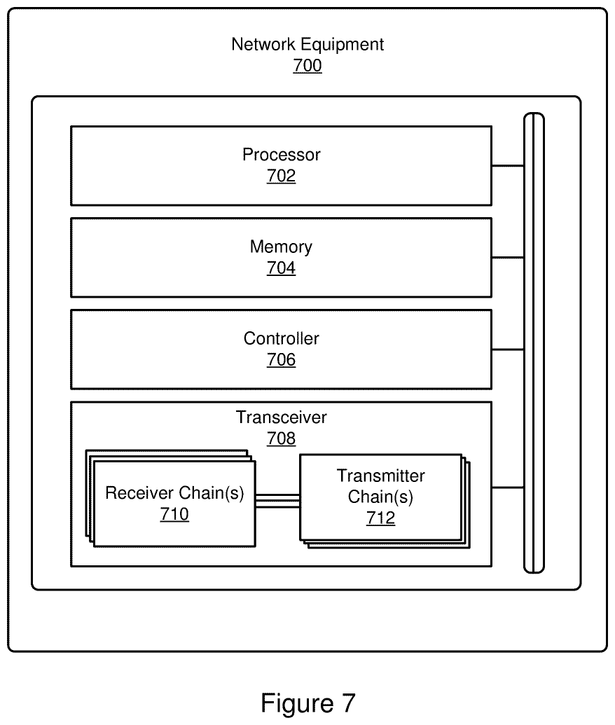

FIG. 7 illustrates an example of a NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 may be configured to support a means for receiving, from a first device, a message comprising: an indication identifying a service or an application; and an indication identifying an analytics associated with the service or the application; transmitting, to a second device, a request for a subscription to the analytics; receiving, from the second device, a response associated with the analytics; and transmitting, to the first device, the response associated with the analytics.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receive the signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

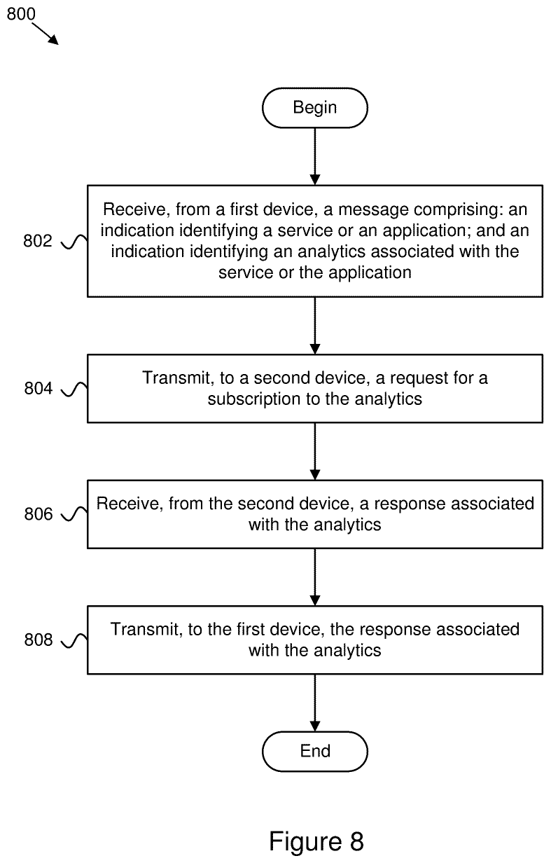

FIG. 8 illustrates a flowchart of a method 800 in accordance with aspects of the present disclosure. The operations of the method 800 may be implemented by a NE as described herein. In some implementations, the NE may execute a set of instructions to control the function elements of the NE to perform the described functions.

At 802, the method may include receiving, from a first device, a message comprising: an indication identifying a service or an application; and an indication identifying an analytics associated with the service or the application. The operations of 802 may be performed in accordance with examples as described herein. In some implementations, aspects of the operations of 802 may be performed by a NE as described with reference to FIG. 7.

At 804, the method may include transmitting, to a second device, a request for a subscription to the analytics. The operations of 804 may be performed in accordance with examples as described herein. In some implementations, aspects of the operations of 804 may be performed by a NE as described with reference to FIG. 7.

At 806, the method may include receiving, from the second device, a response associated with the analytics. The operations of 806 may be performed in accordance with examples as described herein. In some implementations, aspects of the operations of 806 may be performed a NE as described with reference to FIG. 7.

At 808, the method may include transmitting, to the first device, the response associated with the analytics. The operations of 808 may be performed in accordance with examples as described herein. In some implementations, aspects of the operations of 808 may be performed a NE as described with reference to FIG. 7.

It should be noted that the method described herein describes A possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for performing a network function, the apparatus comprising:
at least one memory; and
at least one processor coupled with the at least one memory and configured to cause the apparatus to:
receive, from a first device, a message comprising:
an indication identifying a service or an application; and
an indication identifying an analytics associated with the service or the application;
transmit, to a second device, a request for a subscription to the analytics;
receive, from the second device, a response associated with the analytics; and
transmit, to the first device, the response associated with the analytics.

2. The apparatus of claim 1, wherein the message further comprises an indication identifying a configuration for a resource.

3. The apparatus of claim 2, wherein the configuration for the resource comprises one or more parameters supported by a protocol.

4. The apparatus of claim 3, wherein the protocol comprises:
a hypertext transfer protocol (HTTP); or
a constrained application protocol (CoAP).

5. The apparatus of claim 1, wherein the second device comprises a network entity, a client device, or a combination thereof.

6. The apparatus of claim 1, wherein the first device comprises an analytics consumer.

7. The apparatus of claim 1, wherein:
the apparatus comprises an application data analytics enablement (ADAE) server performing the network function; and
the second device comprises an application layer analytical data repository function (A-ADRF) or an ADAE client.

8. A method of performing a network function, the method comprising:
receiving, from a first device, a message comprising:
an indication identifying a service or an application; and
an indication identifying an analytics associated with the service or the application;
transmitting, to a second device, a request for a subscription to the analytics;
receiving, from the second device, a response associated with the analytics; and
transmitting, to the first device, the response associated with the analytics.

9. The method of claim 8, wherein the message further comprises an indication identifying a configuration for a resource.

10. The method of claim 9, wherein the configuration for the resource comprises one or more parameters supported by a protocol method.

11. The method of claim 10, wherein the protocol method comprises:
a hypertext transfer protocol (HTTP) method; or
a constrained application protocol (CoAP) method.

12. The method of claim 8, wherein the second device comprises a network entity, a client device, or a combination thereof.

13. The method of claim 8, wherein the first device comprises an analytics consumer.

14. The method of claim 8, wherein:
an application data analytics enablement (ADAE) server performs the network function; and
the second device comprises an application layer analytical data repository function (A-ADRF) or an ADAE client.

15. An apparatus for performing a network function, the apparatus comprising:
at least one memory; and
at least one processor coupled with the at least one memory and configured to cause the apparatus to:
transmit a message comprising:
an indication identifying a service or an application; and
an indication identifying an analytics associated with the service or the application; and
receive a response associated with the analytics.

16. The apparatus of claim 15, wherein the message further comprises an indication identifying a configuration for a resource.

17. The apparatus of claim 16, wherein the configuration for the resource comprises one or more parameters supported by a protocol.

18. The apparatus of claim 17, wherein the protocol comprises:
a hypertext transfer protocol (HTTP); or
a constrained application protocol (CoAP).

19. The apparatus of claim 15, wherein the apparatus comprises an analytics consumer.

20. A method of performing a network function, the method comprising:
transmitting a message comprising:
an indication identifying a service or an application; and
an indication identifying an analytics associated with the service or the application; and
receiving a response associated with the analytics.
